(19) United States
(12) Patent Application Publication
(10) Pub. No.: US 2025/0158393 A1
(43) Pub. Date: May 15, 2025

(54) CONTROL APPARATUS, POWER CONTROL SYSTEM, CONTROL METHOD, AND PROGRAM

(71) Applicant: NIPPON TELEGRAPH AND TELEPHONE CORPORATION, Tokyo (JP)

(72) Inventors: Yuji HIGUCHI, Tokyo (JP); Toru TANAKA, Tokyo (JP); Naomichi NAKAMURA, Tokyo (JP); Naoki HANAOKA, Tokyo (JP)

(21) Appl. No.: 18/839,151

(22) PCT Filed: Mar. 24, 2022
(86) PCT No.: PCT/JP2022/014153

§ 371 Date: Aug. 16, 2024

(51) Int. Cl. H02J 1/08; H02J 3/38

(52) U.S. Cl. CPC H02J 1/084; H02J 3/38; H02J 2300/24

(57) ABSTRACT

A control apparatus for executing connection control in a power distribution network in which a solar cell and a plurality of loads are connected and which distributes power from the solar cell in a form of a direct current includes an information acquisition unit that acquires information from the loads connected to the solar cell via the power distribution network, and a control unit that selects a load to be connected to the solar cell so as to increase load side power based on load side power and solar cell side voltages obtained from the information, and controls the power distribution network so as to connect the selected load and the solar cell.

### TECHNICAL FIELD

The present invention relates to a technique for efficiently utilizing power of a solar cell.

### BACKGROUND ART

Photovoltaic power generation using solar cells for converting sunlight into power has been widely used. The power converted from the sunlight is charged, for example, in a storage battery.

Conventionally, a direct current from a solar cell is converted into an alternating current and the alternating current is further converted into a direct current to charge a storage battery in many cases. However, in recent years, as shown in NPL 1, a technique for charging a storage battery with a direct current from a solar cell as it is has been used.

As the technique disclosed in NPL 1, since the number of conversion stages decreases by charging the storage battery with the direct current from the solar cell as it is, the power of a photovoltaic system can be efficiently used.

### CITATION LIST

### Non Patent Literature

### NPL 1:

https://www.itmedia.co.jp/smartjapan/articles/1502/27/news062.html, retrieved on Mar. 11, 2022

### SUMMARY OF INVENTION

### Technical Problem

It is known that photovoltaic power generation has a characteristic in which the amount of power that can be taken out varies depending on the voltage of a load such as a storage battery. However, in the conventional technique shown in NPL 1, it is impossible to maximize the power generated by the solar cell in consideration of this characteristic. That is, the generated power of the solar cell cannot be efficiently utilized.

The present invention has been made in view of the above-described point, and an object of the present invention is to provide a technique for efficiently utilizing the power generated by a solar cell.

### Solution to Problem

According to the disclosed technique, a control apparatus for executing connection control in a power distribution network in which a solar cell and a plurality of loads are connected and which distributes power from the solar cell in a form of a direct current includes
an information acquisition unit that acquires information from the loads connected to the solar cell via the power distribution network, and
a control unit that selects a load to be connected to the solar cell so as to increase load side power based on load side power and solar cell side voltages obtained from the information, and controls the power distribution network so as to connect the selected load and the solar cell.

### Advantageous Effects of Invention

According to the disclosed technique, the power generated by a solar cell can be efficiently utilized.

### BRIEF DESCRIPTION OF DRAWINGS

FIG. 1 is a diagram showing an example of a solar cell and storage batteries connected to a direct current grid.

FIG. 2 is a diagram showing an example of voltage-power characteristics of the solar cell.

FIG. 3 is a diagram showing a configuration example of a power control system.

FIG. 4 is a diagram showing a configuration example of the power control system.

FIG. 5 is a diagram showing a configuration example of a control apparatus.

FIG. 6 is a diagram showing a hardware configuration example of the control apparatus.

FIG. 7 is a flowchart for explaining operations of the control apparatus.

FIG. 8 is a diagram for explaining a specific example.

### DESCRIPTION OF EMBODIMENTS

Hereinafter, embodiments of the present invention (the present embodiments) will be described with reference to the drawings. The embodiments which will be described below are merely examples and embodiments to which the present invention is applied are not limited to the following embodiments.

In the following embodiments, a storage battery is used as a target load to which a solar cell supplies power, but this is an example, and the load other than the storage battery may be used. The storage battery charge power may be called load side power.

### (Overview of Embodiment)

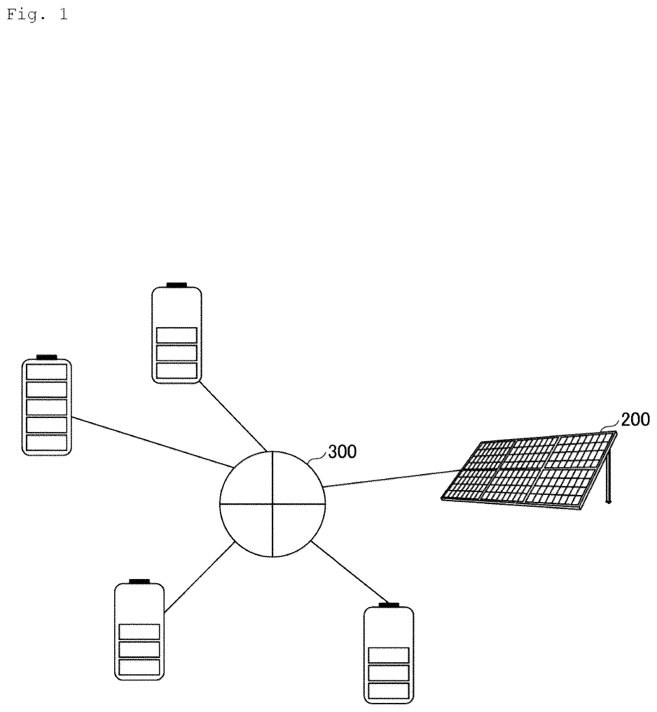

The present embodiment is directed to, as shown in FIG. 1, a system in which a solar cell 200 and a plurality of storage batteries are connected via a direct current grid. Here, the “direct current grid” is used in the sense of a power distribution network in which output from the solar cell 200 that is a direct current power source is not converted into an alternating current and is distributed to the storage batteries in the form of a direct current as it is. The “power distribution network” may be called a “power network”, a “power transmission and distribution network”, or a “power transmission network”. “Power distribution” may be called “power transmission”.

In an example shown in FIG. 1, the solar cell 200 and the plurality of storage batteries are connected via a power router 300. The power router 300 is a device capable of switching a power distribution path of the power outputted from the solar cell 200, and may be called a “path switching device”, a “connection switching device”, a “path selection device”, etc.

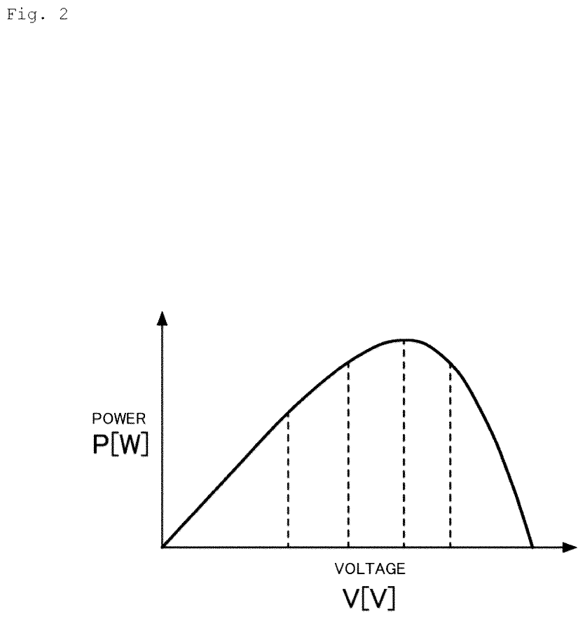

As described above, in photovoltaic power generation, the amount of power that can be taken out varies depending on the voltage of a load. FIG. 2 shows an example of variation. In FIG. 2, the voltage at which a peak of power can be obtained varies depending on the condition of photovoltaic power generation (weather condition or the like). That is, a curve of a graph shown in FIG. 2 varies.

In the present embodiment, the power router 300 performs connection switching so as to distribute the power to a storage battery in which the power outputted from the solar cell 200 becomes large, thereby maximizing the power generated by the solar cell.

Conventionally, maximum power point tracking (MPPT) for controlling the power from a solar cell to be maximum has been known, but there has been no technique for maximizing the power of a solar cell by switching a storage battery, that is, a power distribution destination, as in the present embodiment. Note that, in the present embodiment, for convenience, the control for switching a storage battery may be referred to as “pseudo MPPT”.

The technique according to the present embodiment has the effect of maximizing the power generated by the solar cell by the pseudo MPPT control, in addition to reduction in power conversion loss due to non-use of a power conversion device such as a DC/AC converter.

### (System Configuration Example)

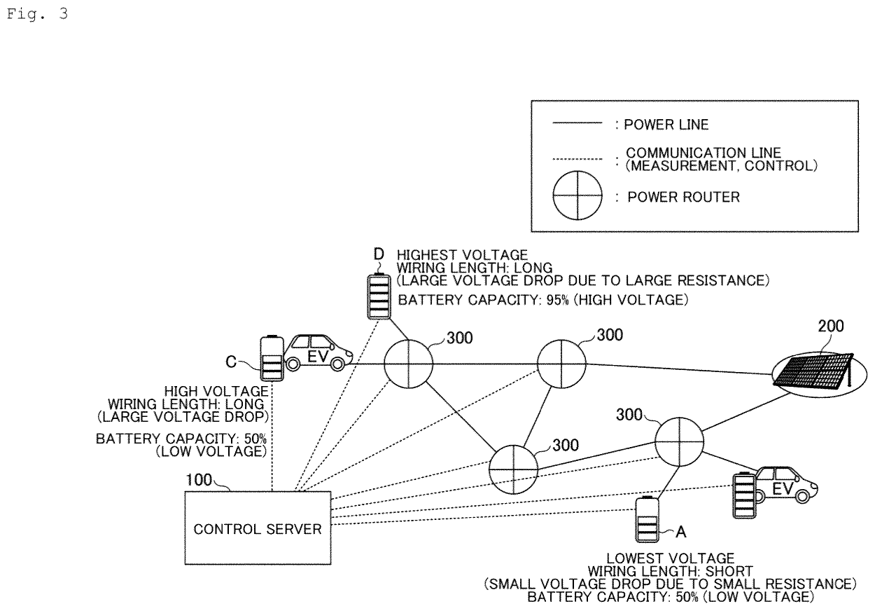

FIG. 3 shows a configuration example of a power control system according to the present embodiment. As shown in FIG. 3, the solar cell 200 and the plurality of storage batteries are connected via the power distribution network, and the power distribution network has a configuration in which a plurality of power routers 300 is connected via power lines. In addition, each storage battery is connected to any power router 300 by the power line. Note that the “power line” may be called a “power distribution line”, a “power transmission line”, or the like.

As shown in FIG. 3, a control server 100 is connected to each storage battery and each power router 300. The control server 100 instructs the power router 300 to perform path control on the basis of information acquired from each storage battery. In the present embodiment, one storage battery is connected to the solar cell 200 at a certain time point. Note that the control server 100 may be called a control apparatus.

In the present embodiment, in consideration of the characteristic of the solar cell 200 as shown in FIG. 2, control is performed while switching an optimal storage battery for maximizing the generated power on the basis of information related to the storage battery capacity, wiring length, and the like, thereby performing the stepwise pseudo MPPT control. A detailed control flow will be described later. Note that, in the following description, “power”, “current”, and “voltage” may be called a “power value”, a “current value”, and a “voltage value”, respectively.

FIG. 3 shows, as an example, situations of storage batteries A, C and D. For example, in the storage battery A, the wiring length between the storage battery A and the solar cell 200 is short. Therefore, resistance is small and voltage drop is small. In addition, since the battery capacity is 50%, the voltage (bus voltage) is low. Therefore, the voltage of the storage battery A is the lowest as compared with the others.

### (Detailed Configuration)

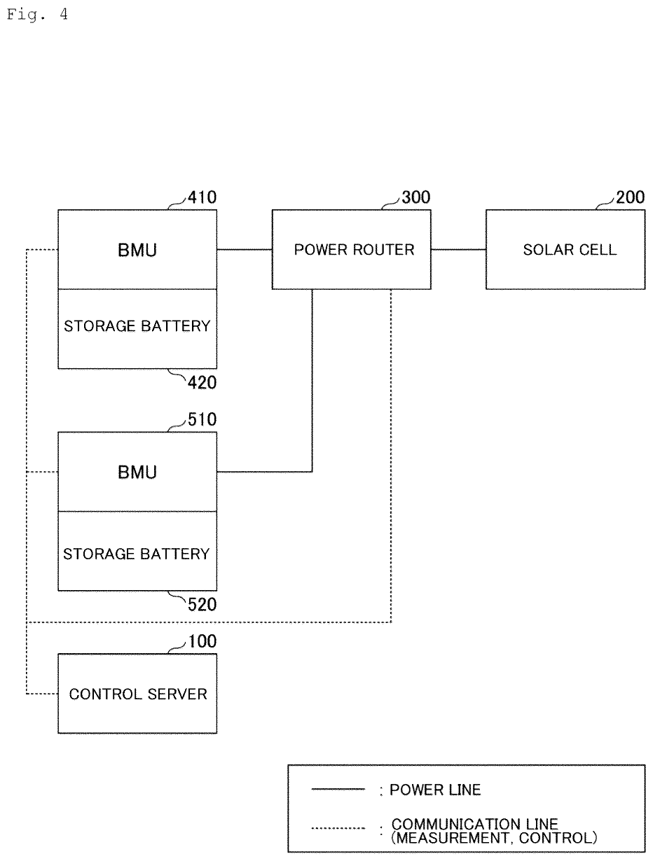

FIG. 4 is a diagram showing a configuration of the power control system according to the present embodiment in detail. FIG. 4 shows two storage batteries and one power router for convenience of illustration.

As shown in FIG. 4, the present power control system includes the solar cell 200, a power router 300, a BMU 410, a storage battery 420, a BMU 510, a storage battery 520, and the control server 100. Each device other than the control server 100 is connected by the power line as shown in the figure. The control server 100 is connected to the power router 300 and each BMU by a communication line. Overviews of the functions of each unit are as follows.

The solar cell 200 converts sunlight into power. The power router 300 performs route change (connection switching) of the power line on the basis of an instruction from the control server 100. The power router 300 may have any mechanism as long as it can perform the route change (connection switching) of the power line. For example, the power router 300 may have a switching mechanism composed of a plurality of breakers or relays.

The battery management units (BMUs) 410 and 510 measure voltage and current of each of the storage batteries and transmit the measured values to the control server 100. The storage batteries 420 and 520 are devices for storing the power.

The control server 100 selects a storage battery that can extract the largest power from the voltage and the current of each of the storage batteries acquired from the BMUs, and issues a route formation instruction to the power router 300 so as to connect the selected storage battery and the solar cell.

### (Configuration Example of Control Server 100)

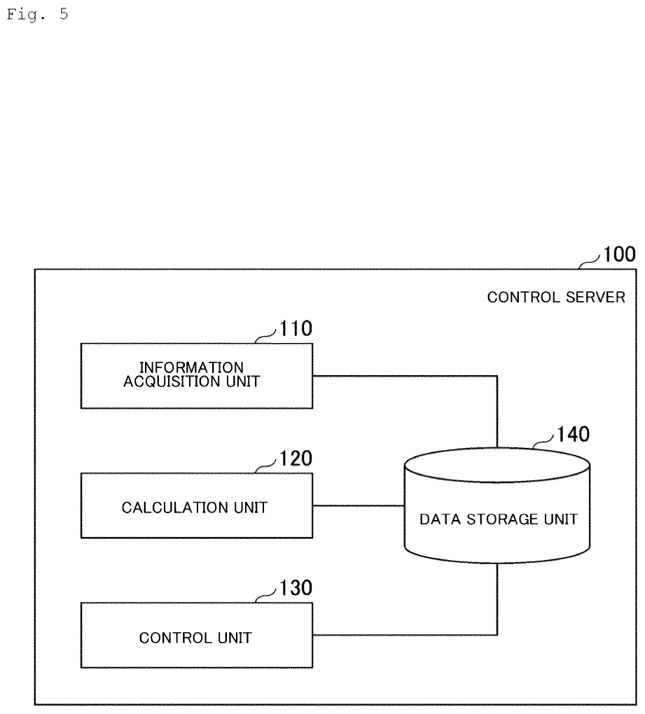

FIG. 5 shows a configuration example of the control server 100. As shown in FIG. 5, the control server 100 includes an information acquisition unit 110, a calculation unit 120, a control unit 130, and a data storage unit 140.

The information acquisition unit 110 acquires the voltage and the current of a storage battery from a BMU. The voltage of the storage battery is voltage of a bus (between two power lines) for charging/discharging the storage battery, and the current is current flowing through the bus. Note that acquiring the voltage and the current from the BMU may be expressed as “acquiring the voltage and the current from the storage battery”.

The calculation unit 120 calculates the storage battery charge power and the solar cell side voltage by using information acquired by the information acquisition unit 110 and information read from the data storage unit 140. The control unit 130 executes operation control of the power router 300 by using calculation results by the calculation unit 120.

The data storage unit 140 stores information (fixed information) used for the calculation by the calculation unit 120, such as a resistance value of the wiring between the solar cell 200 and each storage battery. In addition, the data storage unit 140 stores the information acquired by the information acquisition unit 110 and the calculation results calculated by the calculation unit 120. When the control unit 130 performs the control, the past calculation results are appropriately read from the data storage unit 140 and used.

### (Hardware Configuration Example)

The control server 100 can be realized, for example, by causing a computer to execute a program. The computer may be a physical computer or a virtual machine on a cloud.

That is, the control server 100 can be realized by the execution of a program that corresponds to processing performed in the control server 100 by using hardware resources such as a CPU and a memory provided in the computer. The above-described program can be recorded on a computer-readable recording medium (portable memory or the like) to be stored and distributed. In addition, the above-described program can also be provided through a network such as the Internet or e-mail.

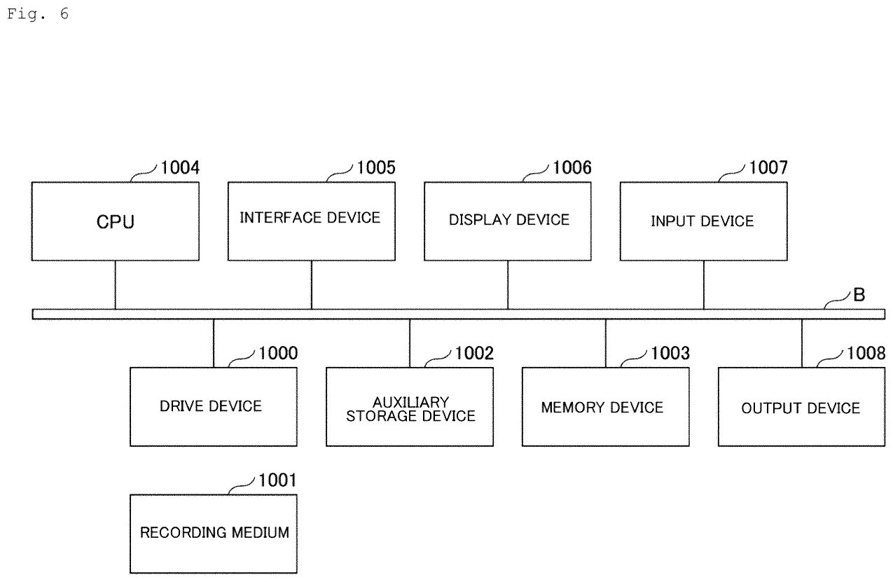

FIG. 6 is a diagram showing a hardware configuration example of the above-described computer. The computer shown in FIG. 6 includes a drive device 1000, an auxiliary storage device 1002, a memory device 1003, a CPU 1004, an interface device 1005, a display device 1006, an input device 1007, and an output device 1008 connected to each other via a bus BS.

The program for realizing processing in the computer is provided by, for example, a recording medium 1001 such as a CD-ROM or a memory card. When the recording medium 1001 which stores the program is set in the drive device 1000, the program is installed in the auxiliary storage device 1002 from the recording medium 1001 via the drive device 1000. However, the program need not necessarily be installed from the recording medium 1001 and may be downloaded from other computers via a network. The auxiliary storage device 1002 stores the installed program and also stores necessary files, data, and the like.

The memory device 1003 reads and stores the program from the auxiliary storage device 1002 when an instruction to start the program is given. The CPU 1004 realizes functions of the control server 100 in accordance with the program stored in the memory device 1003. The interface device 1005 is used as an interface to be connected to the network (communication line). The display device 1006 displays a graphical user interface (GUI) and the like by the program. The input device 1007 is configured of a keyboard, a mouse, buttons, a touch panel, or the like, and is used to input various operation instructions. The output device 1008 outputs the calculation results.

### (Operation Example of Control Server 100)

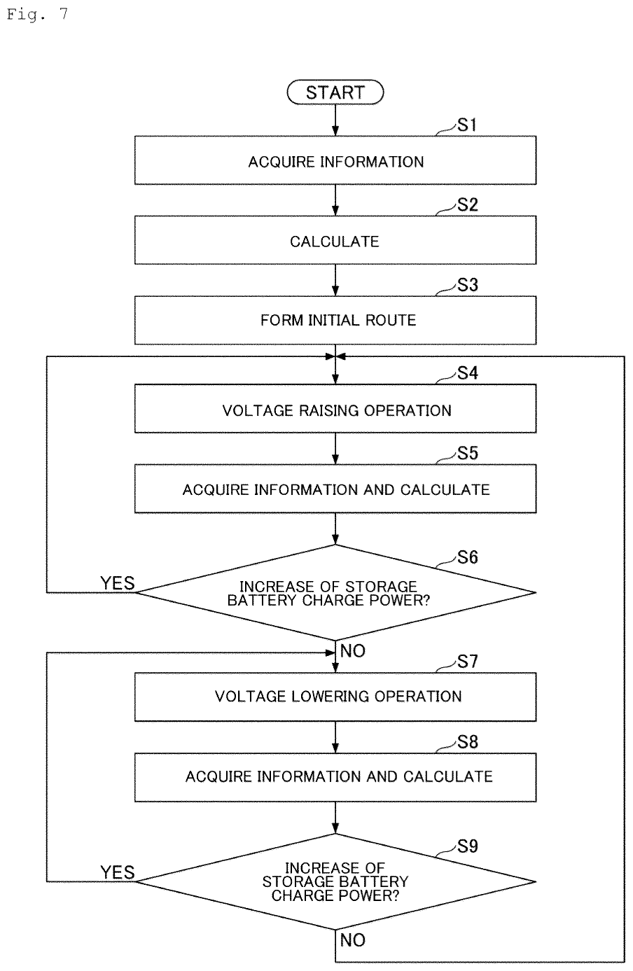

An operation example of the control server 100 having the functional configuration shown in FIG. 5 will be described with reference to a flowchart shown in FIG. 7. First, the processing contents based on the flow will be described, and then a specific example will be described.

In S1, the information acquisition unit 110 acquires information. Specifically, the solar cell 200 is connected in order to each of the plurality of storage batteries in the power distribution network (direct current grid) to be controlled by the present proposed technique by the control of the control unit 130, and the information acquisition unit 110 acquires measured values of the voltage and the current of each of the storage batteries at the time of connection.

In S2, the calculation unit 120 calculates the storage battery charge power and the solar cell side voltage of each of the storage batteries from the measured values acquired in S1 and the resistance value of each path read from the data storage unit 140. Each path is a path between the solar cell 200 and each of the storage batteries.

For a storage battery x (when the storage battery x is connected to the solar cell 200), assuming that the storage battery charge power is set to Pₓ, the storage battery voltage is set to Vbₓ, and the storage battery current is set to Iₓ, the calculation unit 120 calculates the storage battery charge power Pₓ of the storage battery x by using an equation of Pₓ=Vbₓ×Iₓ.

For the storage battery x (when the storage battery x is connected to the solar cell 200), assuming that the solar cell side voltage is set to Vpₓ, the storage battery voltage is set to Vbₓ, the resistance value of the wiring is set to Rₓ, and the storage battery current (solar cell current) is set to Iₓ, the calculation unit 120 calculates the solar cell side voltage Vpₓ by using an equation of Vpₓ=Vbₓ+Rₓ×Iₓ.

In S3, the control unit 130 instructs the power router 300 to form a route so that, first, a storage battery whose storage battery power becomes the largest and the solar cell 200 are connected on the basis of the calculation results in S2. After the route is formed (changed), charging is performed for a fixed period of time T1. In the subsequent processing, charging is performed only for the fixed period of time T1 after the route is formed (changed).

During charging (for example, a time point close to the end of the period of time T1), the information acquisition unit 110 acquires measured values of the current and the voltage from the storage battery connected to the solar cell 200. Then, the pseudo MPPT control is executed for each T1.

The processing of S4 to S9 described below is the pseudo MPPT control. Note that although the processing starts from a voltage raising operation in the present embodiment, this is an example. It may start from a voltage lowering operation.

In S4, the control server 100 performs the voltage raising operation. Specifically, the control unit 130 selects a route having the largest past storage battery charge power from among routes each having the solar cell side voltage higher than the solar cell side voltage calculated from the current measured values of the current and the voltage on the basis of the information stored in the data storage unit 140, and performs the route change.

The past storage battery charge power is the latest past storage battery charge power in loop control of S4 to S9. Note that, in the initial stage, values calculated in S1 and S2 may be used for a storage battery having no connection history with the solar cell 200 in the loop control of S4 to S9.

In S5, the information acquisition unit 110 acquires the storage battery voltage and the storage battery current in the route changed in S4, and the calculation unit 120 calculates the storage battery charge power and the solar cell side voltage by using them.

In S6, the control unit 130 compares the storage battery charge power before the route change with the storage battery charge power after the route change, and determines whether or not the storage battery charge power after the route change is greater than the storage battery charge power before the route change.

When the determination result in S6 is Yes (increase), the processing returns to S4 and the processing from S4 is executed again. When the determination result in S6 is No (decrease), the processing proceeds to S7.

In S7, the control server 100 performs the voltage lowering operation. Specifically, the control unit 130 selects a route having the largest past storage battery charge power from among routes each having the solar cell side voltage lower than the latest solar cell side voltage calculated in S5 on the basis of the information stored in the data storage unit 140, and performs the route change.

In S8, the information acquisition unit 110 acquires the storage battery voltage and the storage battery current in the route changed in S7, and the calculation unit 120 calculates the storage battery charge power and the solar cell side voltage by using them.

In S9, the control unit 130 compares the storage battery charge power before the route change with the storage battery charge power after the route change, and determines whether or not the storage battery charge power after the route change is less than the storage battery charge power before the route change.

When the determination result in S9 is Yes (increase), the processing returns to S7 and the processing from S7 is executed again. When the determination result in S9 is No (decrease), the processing proceeds to S4 and the processing from S4 is executed again.

### Specific Example

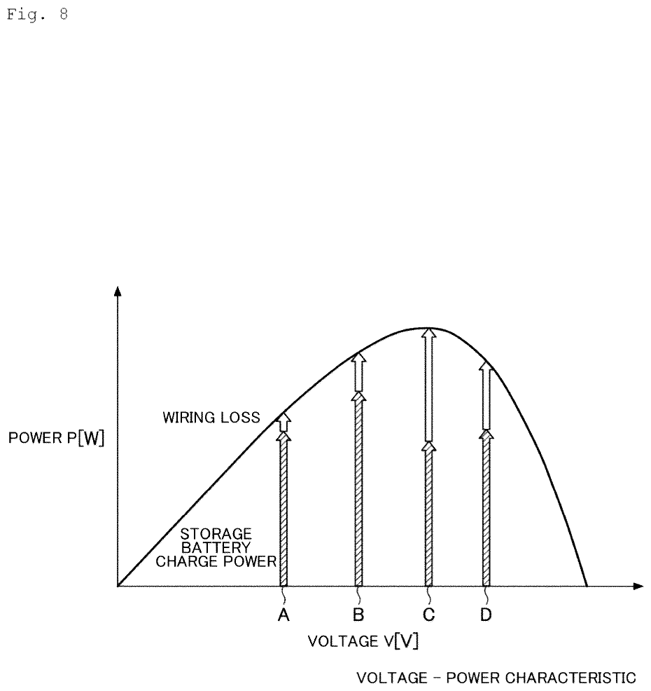

Subsequently, a specific example of the processing on the basis of the flow shown in FIG. 7 will be described. Here, it is assumed that the voltage-power characteristic of the solar cell 200 has the shape shown in FIG. 8. In addition, it is assumed that the solar cell side voltages of the storage battery A, the storage battery B, the storage battery C, and the storage battery D, respectively, are A, B, C, and D on the horizontal axis of FIG. 8.

Further, the storage battery charge power and the wiring loss of each of the storage battery A, the storage battery B, the storage battery C, and the storage battery D are shown in FIG. 7. As shown in FIG. 7, the “storage battery charge power+wiring loss” is the power outputted from the solar cell 200. Note that the storage battery A, the storage battery C, and the storage battery D correspond to the storage battery A, the storage battery C, and the storage battery D shown in FIG. 3.

In the following description, a route from the storage battery A to the solar cell 200 is set to a route A, a route from the storage battery B to the solar cell 200 is set to a route B, a route from the storage battery C to the solar cell 200 is set to a route C, and a route from the storage battery D to the solar cell 200 is set to a route D.

In S3 in FIG. 7, the control unit 130 instructs the power router 300 to connect the storage battery B having the largest storage battery power and the solar cell 200, thereby forming the route B as the initial route.

In S4, the control unit 130 selects the route D as a route having the largest past storage battery charge power from among the route C and the route D each having the solar cell side voltage higher than the solar cell side voltage of the route B on the basis of the information stored in the data storage unit 140, and performs the change to the route D.

In S5, the information acquisition unit 110 acquires the storage battery voltage and the storage battery current in the route D changed in S4, and the calculation unit 120 calculates the storage battery charge power and the solar cell side voltage in the route D by using them.

In S6, the control unit 130 compares the storage battery charge power before the route change with the storage battery charge power after the route change, and determines whether or not the storage battery charge power after the route change is greater than the storage battery charge power before the route change.

As shown in FIG. 8, since the storage battery charge power of the route D is lower than the storage battery charge power of the route B, the processing proceeds to S7.

In S7, the control unit 130 selects the route B as a route having the largest past storage battery charge power from among the routes (A, B, and C) each having the solar cell side voltage lower than the latest solar cell side voltage (D) calculated in S5 on the basis of the information stored in the data storage unit 140, and performs the change to the route B.

In S8, the information acquisition unit 110 acquires the storage battery voltage and the storage battery current in the route B changed in S7, and the calculation unit 120 calculates the storage battery charge power and the solar cell side voltage by using them.

In S9, the control unit 130 determines whether or not the storage battery charge power after the route change is greater than the storage battery charge power before the route change.

As shown in FIG. 8, since the storage battery charge power of the route B is greater than the storage battery charge power of the route D, the processing returns to S7. Thereafter, the route A is selected.

The processing is continued as described above. Note that, in the above description, for convenience of description, the storage battery charge power and the solar cell side voltage are assumed to be fixed values shown in FIG. 8, but actually the values change for each measurement.

In addition, in the flow of FIG. 7, when selecting a route as a change destination, a route having the largest past storage battery charge power is selected from among routes each having the solar cell side voltage higher or lower than the current solar cell side voltage, but this is an example.

In the voltage raising operation, when selecting a route as a change destination, a route having the solar cell side voltage closest to the current solar cell side voltage may be selected from among routes each having the solar cell side voltage higher than the current solar cell side voltage. In the voltage lowering operation, when selecting a route as a change destination, a route having the solar cell side voltage closest to the current solar cell side voltage may be selected from among routes each having the solar cell side voltage lower than the current solar cell side voltage.

In addition, in the flow of FIG. 7, although the control server 100 calculates the storage battery charge power and the solar cell side voltage on the basis of the measured values, the load side may calculate the storage battery charge power and the solar cell side voltage from the measured values, and the information acquisition unit 110 may acquire the storage battery charge power and the solar cell side voltage from the load side.

### Advantageous Effects of Embodiment

According to the above-described technique, it is possible to maximize the power generated by the solar cell in the direct current grid in which the solar cell and the plurality of loads (storage batteries or the like) are connected.

### (Supplements)

The following supplement items are further disclosed in relation to the embodiments described above.

### (Supplement Item 1)

A control apparatus for executing connection control in a power distribution network in which a solar cell and a plurality of loads are connected and which distributes power from the solar cell in a form of a direct current, the control apparatus including
a memory, and
at least one processor connected to the memory,
wherein
the processor
acquires information from the loads connected to the solar cell via the power distribution network, and
selects a load to be connected to the solar cell so as to increase load side power based on the load side power and solar cell side voltages obtained from the information, and controls the power distribution network so as to connect the selected load and the solar cell.

### (Supplement Item 2)

The control apparatus according to supplement item 1, wherein in a voltage raising operation of selecting a load so as to increase a solar cell side voltage, the processor selects a load having largest load side power as a load to be connected to the solar cell from among one or more loads having solar cell side voltages higher than a current solar cell side voltage, and
in a voltage lowering operation of selecting a load so as to decrease a solar cell side voltage, the processor selects a load having largest load side power as a load to be connected to the solar cell from among one or more loads having solar cell side voltages lower than a current solar cell side voltage.

### (Supplement Item 3)

The control apparatus according to supplement item 2, wherein in a case where the load to be connected to the solar cell is changed, the processor continues the voltage raising operation or the voltage lowering operation when load side power after the change is greater than load side power before the change, and changes the voltage raising operation to the voltage lowering operation or changes the voltage lowering operation to the voltage raising operation when the load side power after the change is less than the load side power before the change.

### (Supplement Item 4)

The control apparatus according to supplement item 1, wherein the processor acquires a voltage value and a current value from each of the loads connected to the solar cell, calculates load side power of each of the loads from the voltage value and the current value, and calculates a solar cell side voltage from the voltage value, the current value, and a resistance value between the solar cell and each of the loads.

### (Supplement Item 5)

A power control system including the control apparatus according to any one of supplement items 1 to 4 and the solar cell.

### (Supplement Item 6)

A control method performed by a computer used as a control apparatus for executing connection control in a power distribution network in which a solar cell and a plurality of loads are connected and which distributes power from the solar cell in a form of a direct current, the control method including
an information acquisition step of acquiring information from the loads connected to the solar cell via the power distribution network, and
a control step of selecting a load to be connected to the solar cell so as to increase load side power based on load side power and solar cell side voltages obtained from the information, and controlling the power distribution network so as to connect the selected load and the solar cell.

### (Supplement Item 7)

A program for causing a computer to serve as each unit in the control apparatus according to any one of supplement items 1 to 4.

Although the embodiment has been described above, the present invention is not limited to the specific embodiment, and various modifications and changes can be made within the scope of the gist of the present invention described in the claims.

### REFERENCE SIGNS LIST

100 Control server
110 Information acquisition unit
120 Calculation unit
130 Control unit
140 Data storage unit
200 Solar cell
300 Power router
410 BMU
420 Storage battery
510 BMU
520 Storage battery
1000 Drive device
1001 Recording medium
1002 Auxiliary storage device
1003 Memory device
1004 CPU
1005 Interface device
1006 Display device
1007 Input device
1008 Output device

1. A control apparatus for executing connection control in a power distribution network in which a solar cell and a plurality of loads are connected and which distributes power from the solar cell in a form of a direct current, the control apparatus comprising:
a processor; and
a memory storing program instructions that cause the processor to:
acquire information from the loads connected to the solar cell via the power distribution network; and
select a load to be connected to the solar cell so as to increase load side power based on load side power and solar cell side voltages obtained from the information, and control the power distribution network so as to connect the selected load and the solar cell.

2. The control apparatus according to claim 1, wherein
in a voltage raising operation of selecting a load so as to increase a solar cell side voltage, the program instructions cause the processor to select a load having largest load side power as a load to be connected to the solar cell from among one or more loads having solar cell side voltages higher than a current solar cell side voltage, and
in a voltage lowering operation of selecting a load so as to decrease a solar cell side voltage, program instructions cause the processor to select a load having largest load side power as a load to be connected to the solar cell from among one or more loads having solar cell side voltages lower than a current solar cell side voltage.

3. The control apparatus according to claim 2, wherein
in a case where the load to be connected to the solar cell is changed, the program instructions cause the processor to continue the voltage raising operation or the voltage lowering operation when load side power after the change is greater than load side power before the change, and change the voltage raising operation to the voltage lowering operation or change the voltage lowering operation to the voltage raising operation when the load side power after the change is less than the load side power before the change.

4. The control apparatus according to claim 1, wherein
the program instructions cause the processor to acquire a voltage value and a current value from each of the loads connected to the solar cell, calculate load side power of each of the loads from the voltage value and the current value, and calculate a solar cell side voltage from the voltage value, the current value, and a resistance value between the solar cell and each of the loads.

5. A power control system comprising:
the control apparatus of claim 1; and
the solar cell.

6. A control method performed by a control apparatus for executing connection control in a power distribution network in which a solar cell and a plurality of loads are connected and which distributes power from the solar cell in a form of a direct current, the control method comprising:
acquiring information from the loads connected to the solar cell via the power distribution network; and
selecting a load to be connected to the solar cell so as to increase load side power based on load side power and solar cell side voltages obtained from the information, and controlling the power distribution network so as to connect the selected load and the solar cell.

7. A non-transitory computer-readable recording medium storing a program for causing a computer to execute the control method of claim 6.
